(19) United States
(12) Patent Application Publication
(10) Pub. No.: US 2023/0144702 A1
(43) Pub. Date: May 11, 2023

(54) PARTNER NETWORK SERVICES

(71) Applicant: Wells Fargo Bank, N.A., San Francisco, CA (US)

(72) Inventors: Adelina Jannet, Secunderabad (IN); Pavitra V, Hyderabad (IN); Chinna Bala Krishna Sanna Balappa, Medak (IN); Srikanth Kandoti, Hyderabad (IN)

(21) Appl. No.: 16/368,059

(22) Filed: Mar. 28, 2019

(51) Int. Cl. G06Q 30/06; H04L 12/58; G06Q 10/10

(52) U.S. Cl. CPC G06Q 30/0635; H04L 51/20; G06Q 10/1095

(57) ABSTRACT

Partner network stores facilitate provisioning of services to customers. Customer requests for services of an institution are received in which each request is associated with a customer of the institution and includes service information. A central location can be determined based on the service information including customer location. A partner within a predetermined radius of the central location can be determined using a partner database. The partner can be converted into an ad hoc location by deploying an ad hoc service solution to the partner, and the ad hoc location can subsequently be communicated to customers.

### BACKGROUND

Certain types of transactions and/or services are generally processed and/or availed at brick and mortar owned stores or using the interne. For example, banking customers have to visit an Automated Teller Machine (ATM) to withdraw cash bills or a bank branch to conduct a banking transaction. It is cost prohibitive to set up fulltime operating bank stores in remote areas of minimal density or number of customers. Further, if a customer needs immediate or time sensitive assistance from an institution, reaching out to customer support can be inefficient due to substantial wait times.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of partner network services. A method includes monitoring customer requests for services of an institution, wherein each request is associated with a customer and includes service information. The method includes determining an ad hoc location to fulfill a subset of the customer requests. The method includes communicating the ad hoc location to at least one customer.

A system of the innovation can include a request component that monitors customer requests for services of an institution, wherein each request is associated with a customer and includes service information. A determination component determines an ad hoc location to fulfill a subset of the customer requests. A communication component communicates the ad hoc location to at least one customer.

A computer readable medium can include instructions to control one or more processors. The instructions can include monitoring customer requests for services of an institution, wherein each request is associated with a customer and includes service information. The instructions can include optimizing a general location based on the service information. The instructions can include determining a partner within a predetermined radius of the general location using a partner database. The instructions can include converting the partner into an ad hoc location by deploying an ad hoc service solution to the partner. The instructions can include communicating the ad hoc location to at least one customer

In aspects, the subject innovation provides substantial benefits in terms of partner network services. One advantage resides in providing services to customers in remote areas. Another advantage resides in a smaller brick and mortar footprint for an institution.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system of the present innovation.

FIG. 2 illustrates an example component diagram of a request component.

FIG. 3 illustrates an example component diagram of a determination component.

FIG. 4 illustrates a method for partner network services.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

In remote and less densely populated areas, it is typically cost prohibitive to establish and maintain brick and mortar stores. Further, network-based service may not be sufficient to handle certain kinds of requests, such as cash withdraws in a banking context. In addition, timely assistance from customer support by way of phone, or other communication medium, is often challenging due to less than ideal wait times as well as inherent limitations of remote support.

Details below generally pertain to partner network services. Rather than requiring an entity to establish and maintain brick and mortar stores to service customers, a network of pre-existing partner stores can be employed. Customer requests for service can be received by a system. Subsequently, customer requests can be aggregated and a location of a partner identified to service each of the customer requests. The location of a partner can be identified by determining a location central to the location of customers and identifying partners within a predetermined radius of the central location. Steps can next be taken to establish a mobile store at an identified partner location, and customers can be notified of the location of the partner store and timing for servicing of the customer's request. By way of example, a mobile bank can be established in a local grocery store such that a customer can visit and take advantage of banking services at the grocery store while shopping. Consequently, customers can avail themselves of banking services in identified partner stores without visiting a physical bank or automated teller machine (ATM) center.

Various aspects of the subject innovation are now described in more detail with reference to the annexed drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

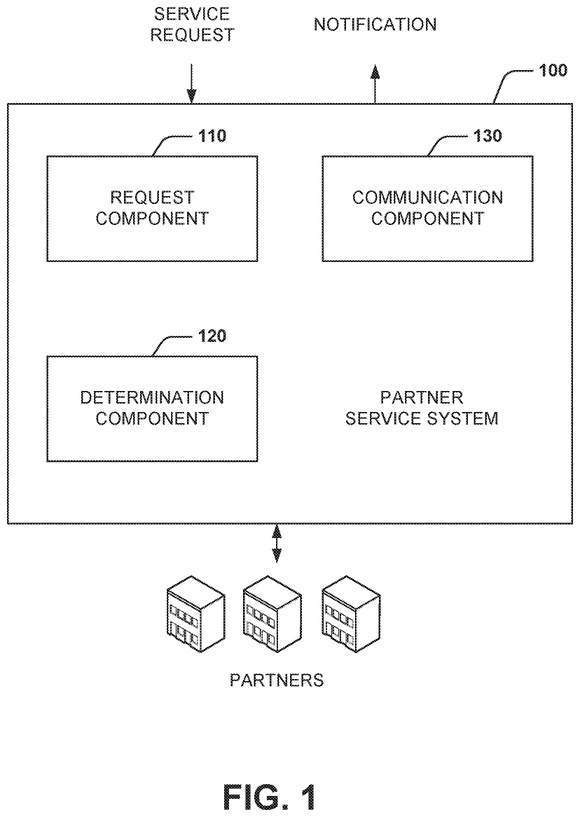

FIG. 1 illustrates a system 100 for partner-enabled services. The system 100 includes a request component 110. The request component 110 monitors customer requests for services of an institution. Each request is associated with a customer and includes service information. In some embodiments, the request component 110 receives the customer requests through at least one of social media, application submission, web portal, website, email, text message, phone call, and/or the like.

In some embodiments, the request component 110 parses each request to extract the service information. The service information can include at least one of a date, a time, a location, a service type, and/or the like. For example, a banking customer submits a customer request having service information. The service information can be a cash deposit for January 12 at 1 pm in downtown area of City X. The request component 110 can receive multiple customer requests over time. The request component 110 determines a subset of customer requests based on extracted service information. In some embodiments, the request component 110 can group the customer requests into subsets based on the time, date, location, service type, and/or a combination of service information.

The system 100 includes a determination component 120. The determination component 120 determines an ad hoc location to fulfill a subset of customer requests. The determination component 120 can determine a general location based on the service information. In some embodiments, the determination component 120 can determine a central location based on an aggregate of locations in the subset of customer requests. For example, the central location between two points computed could be the midpoint between the two points. In other embodiments, the central location can represent a location that is central to all or most of the customer requested locations of the service information in the subset of customer requests. The central location can be represented as a point or set of points defining an area. Further, the central location can be expressed as an address, global positioning satellite (GPS) coordinates, or map pin, among other representations.

The determination component 120 determines a partner within a predetermined radius of the central location. A partner can be a brick and mortar location of a store or other entity that has the capability to provide the requested services and/or allow an ad hoc service solution. In some embodiments, the determination component 120 utilizes a partner database that includes a list of pre-approved partners or partners available to be verified. In other embodiments, the determination component 120 determines potential partners near the general location.

In some embodiments, the determination component 120 can request an ad hoc service solution to be deployed to a partner. The determination component 120 can verify the partner based on one or more partner credentials. The partner credentials can include at least one of service rating, capability, availability, and/or the like.

The determination component 120 converts the partner into the ad hoc location by deploying an ad hoc service solution to the partner. The ad hoc service solution can be a customer representative or agent, a mobile kiosk, a mobile truck, and/or the like. In some embodiments, the ad hoc service solution can be to empower an employee of the partner to provide services to fulfil customer requests. The ad hoc solution can provide services to fulfill customer requests such that a customer can go to the ad hoc location at a particular date or time to receive the services requested.

The system 100 includes a communication component 130. The communication component 130 communicates the ad hoc location to at least one customer. The communication component 130 generates a notification. In some embodiments, the notification includes the ad hoc location. A notification could be an email, a text message, or a phone call, among other things. In some embodiments, the notification also includes a date, time(s), available services, partner specific contact information, and/or the like. In some embodiments, the communication component 130 sends the notification to customers associated with each request in the subset of customer requests. In other embodiments, the communication component 130 sends the notification to each customer that submitted a request or each customer within a predetermined radius and/or in a proximate region of the ad hoc location.

In some embodiments, the communication component 130 can determine a schedule with appointments for customers that submitted a request to visit the ad hoc location. The communication component 130 utilizes an algorithm to determine an optimized schedule and/or resolve conflicts. In other embodiments, the communication component 130 sends a notification to a customer regarding a divergence from the requested time if not available. It is appreciated that other automated scheduling solutions may be applicable and considered.

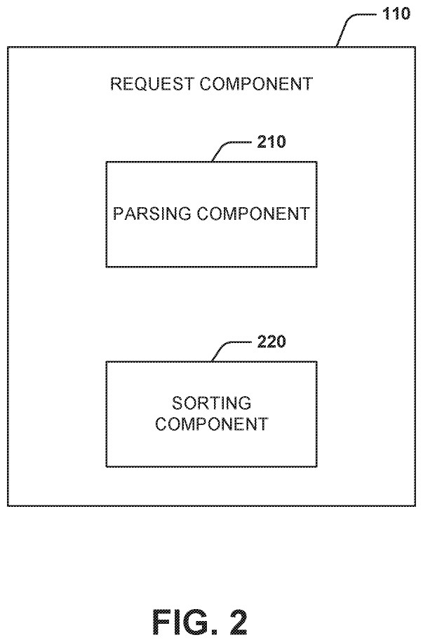

FIG. 2 illustrates a detailed component diagram of a request component 110. The system 100 includes a request component 110. The request component 110 monitors customer requests for services of an institution. Each request is associated with a customer and includes service information. In some embodiments, the request component 110 receives the customer requests through at least one of social media, application submission, web portal, website, email, text message, phone call, and/or the like.

In some embodiments, the request component 110 includes a parsing component 210. The parsing component 210 parses each request to extract the service information. The service information can include at least one of a date, a time, a location, a service type, and/or the like. For example, a banking customer submits a customer requests having service information. The service information can be a cash deposit for January 12 at 1 pm in downtown area of City X.

The request component 110 includes a sorting component 220. The request component 110 can receive multiple customer requests over time. The sorting component 220 determines a subset of customer requests based on extracted service information. In some embodiments, the sorting component 220 can group the customer requests into subsets based on the time, date, location, service type, and/or a combination of service information.

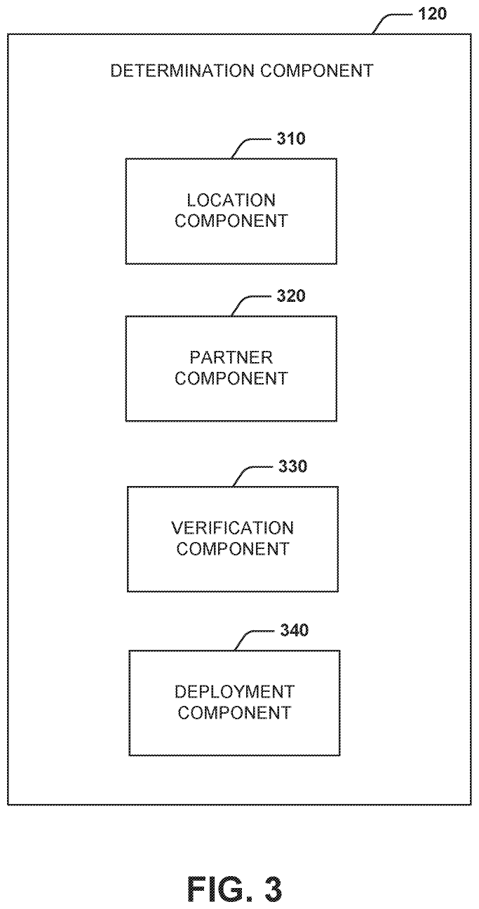

FIG. 3 illustrates a detailed component diagram of a determination component 120. The determination component 120 determines an ad hoc location to fulfill a subset of customer requests. The determination component 120 includes a location component 310. The location component 310 determines a location based on the service information. In some embodiments, the location component 310 can utilize an algorithm and/or the like to determine a central location based on an aggregate of locations in the subset of customer requests. In some embodiments, the location can be an address, GPS coordinates, location indicator, map pin, and/or the like. In other embodiments, the location can represent a central location that is central to all or most of the customer requested locations of the service information in the subset of customer requests. In other words, the determination component 120 can seek to determine a location that would be convenient for all or most customer requested locations.

The determination component 120 includes a partner component 320. The partner component 320 determines a partner within a predetermined radius of the location determined by the location component 120. A partner can be a brick and mortar location of a store or other entity that has the capability to provide the requested services and/or allow an ad hoc service solution. In some embodiments, the partner component 320 utilizes a partner database that includes a list of pre-approved partners or partners available to be verified. In other embodiments, the partner component 320 determines potential partners near the determined location, such as a central location between a subset of customers.

The determination component 120 includes a verification component 330. The verification component 330 can verify the partner. The verification component 330 can verify based on one or more partner credentials. In some embodiments, the partner credentials can include at least one of service rating, capability, availability, and/or the like. In other embodiments, the partner credentials include an approval, authorization, pre-approval, and/or the like from the institution and/or system 100.

In some embodiments, the determination component 120 can request an ad hoc service solution to be deployed to a partner. The determination component 120 includes a deployment component 340. The deployment component 340 converts the partner into the ad hoc location by deploying an ad hoc service solution to the partner. The ad hoc service solution can be a customer representative or agent, a mobile kiosk, a mobile truck, and/or the like. The ad hoc service solution is deployed and/or placed at or with the partner. In some embodiments, the ad hoc service solution can be to empower an employee of the partner to provide services to fulfil customer requests. The ad hoc solution can provide services to fulfill customer requests such that a customer can go to the ad hoc location at a particular date or time to receive the services requested.

The aforementioned system, environment, or the like has been described with respect to interactions between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communications between systems, components, and/or sub-components can be accomplished in accordance with either a push and/or pull model of control. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the location component 310 can employ such mechanisms in determining a location based on a variety of factors such as day of the week, time of day, weather, and/or traffic as well as feedback. As another non-limiting example, the partner component 320 and/or verification component can utilize such mechanism to predict whether or not addition a new partner should be added, for example based on customer requests and service information as well as demographic information concerning a partner and partner location.

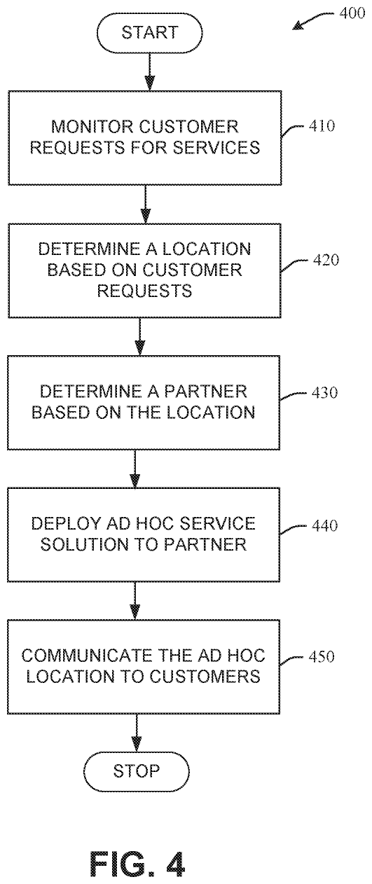

In view of the system 100 described above, a method that may be implemented in accordance with the disclosed subject matter will be better appreciated with reference to the flow chart diagram of FIG. 4. While for purposes of simplicity of explanation, methods are shown and described as a series of blocks, it is to be understood and appreciated that the innovation is not limited by the order of the blocks as some blocks may occur in different orders and/or concurrently with other blocks, as some blocks from what is depicted and described herein. Moreover, not all illustrated blocks may be required to implement a method of the innovation. Further, each block can be implemented by computer program instructions that can be provided to a processor to produce a particular machine, such that the instructions executing on the processor create a means for implementing actions specified by a flow chart block.

FIG. 4 illustrates an example method 400 for partner network services. At 410, customer requests for services of an institution are monitored. Each request is associated with a customer and includes service information. In some embodiments, the customer requests can be received through at least one of social media, application submission, web portal, website, email, text message, phone call, and/or the like. In one instance, the customer requests can be for bank services such as opening an account, depositing or withdrawing cash or applying for a loan.

At 420, a location is determined based on the service information. In one embodiment, the location can be determined that is central to all or most of a subset of customers submitting requests. In some embodiments, the location can be an address, GPS coordinates, location indicator, map pin, or any other mechanism that can capture a geographic position.

At 430, a partner within a predetermined radius of the location is determined. A partner can be a brick and mortar location of a store or other entity that has the capability to provide the requested services and/or allow an as needed service solution. In some embodiments, a partner can be determined utilizing a partner database that includes a list of pre-approved partners. In other embodiments, the partner can be determined from a set of potential partners near the location associated with the customer requests.

At 440, the partner is converted into an ad hoc location by deploying an ad hoc service solution to the partner. The ad hoc service solution can be a customer representative or agent, a mobile kiosk, a mobile truck, and/or the like. The ad hoc service solution is deployed and/or placed at or with the partner. In some embodiments, the ad hoc service solution can be to empower an employee of the partner to provide services to fulfil customer requests.

At 450, the ad hoc location is communicated to customers of the institution. In some embodiments, the ad hoc location can be communicated through a notification. The notification can be an email, a test message, phone call, or an application alert, among others. In some embodiments, the notification also includes a date, time(s), available services, partner specific contact information, and/or the like. Notifications can be sent to customers associated with each request in the subset of customer requests to be serviced at the ad hoc location.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a computer and the computer can be a component. One or more components residing within a process or thread of execution and a component may be localized on one computer or distributed between two or more computers.

The conjunction “or” as used in this description and appended claims is intended to mean an inclusive “or” rather than an exclusive “or,” unless otherwise specified or clear from context. In other words, “X” and “Y” is intended to mean any inclusive permutations of “X” and Y.” For example, if “‘A’ employs ‘X’,” “‘A’ employs ‘Y’,” or “‘A’ employs both ‘X’ and ‘Y’,” then “‘A’ employs ‘X’ or ‘Y’” is satisfied under any of the foregoing instances.

Further, to the extent the terms “includes,” “contains,” “has,” “having” or variations in form are thereof are used in either the detailed descriptions or the claims, such terms are intended to be inclusive in a manner similar to the term “comprising” as “comprising” is interpreted when employed as a transitional word in a claim.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

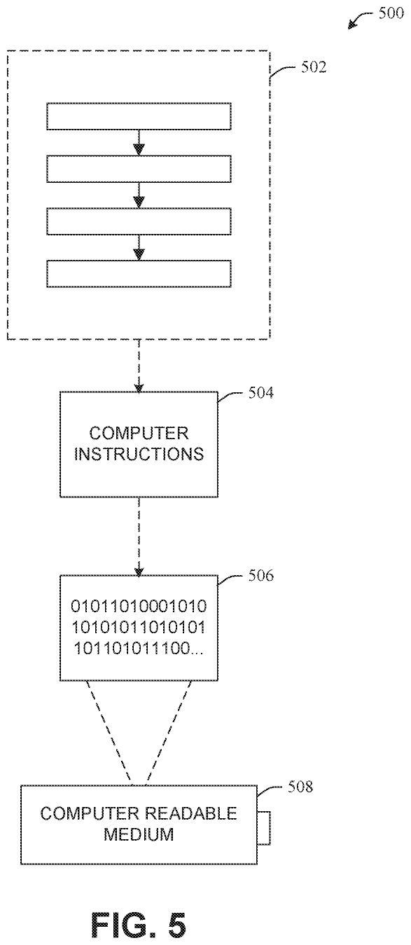

One embodiment of the subject innovation can involve a computer-readable medium comprising processor-executable instructions configured to implement one or more embodiments of the techniques presented herein. An embodiment of a computer-readable storage medium or a computer-readable device that is devised in these ways is illustrated in FIG. 5, wherein an implementation 500 comprises a computer-readable storage medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connection with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

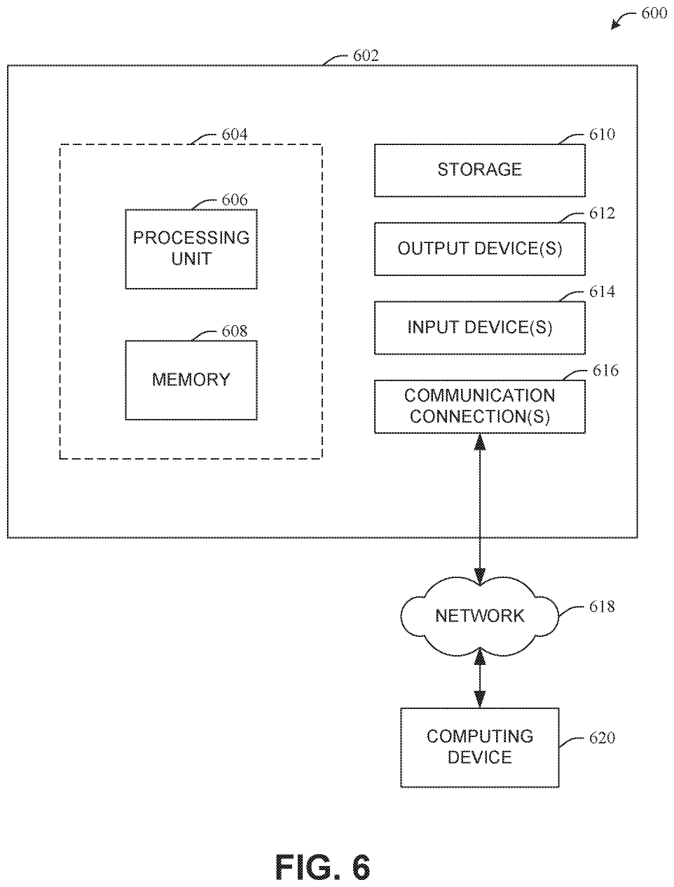

With reference to FIG. 6 and the following discussion, provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein comprises two distinct and mutually exclusive types, namely computer storage media and communication media. Computer storage media includes storage devices such as memory devices (e.g., random access memory (RAM), read-only memory (ROM), electrically erasable programmable read-only memory (EEPROM) . . . ), magnetic storage devices (e.g., hard drive, floppy disk, tape . . . ) optical disks (e.g., compact disk (CD), digital versatile disk (DVD) . . . ) solid state devices (e.g., solid state drive (SSD), flash memory drive (e.g., card, stick, key drive . . . ) . . . ), or any other like media that store, as opposed to transmit or communicate, desired information accessible by the device 602. Accordingly, computer storage media excludes modulated data signals as well as that described with respect to communication media. The memory 608 and the storage 610 are examples of computer storage media.

Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims.

1. A computer-implemented method, comprising:
predefining, by a partner component, a plurality of partner locations, wherein partner locations of the plurality of partner locations are predefined to allow deployment of a mobile vehicle at the partner locations;
receiving, by a request component of a computing device, a set of customer requests for services of an institution, wherein each request of the set of customer requests is associated with a respective customer and includes service information comprising a respective customer-requested location, a respective customer-requested time, and a respective service type;
parsing, by the request component, the set of customer requests to extract, from the service information included in each of the set of customer requests, a set of customer-requested times, a set of customer-requested locations, and a set of service types;
determining, by a sorting component, a subset of the set of customer requests based on one or more of the set of customer-requested times, the set of customer-requested locations, and the set of service types;
determining, by a determination component of the computing device, a central location for the subset of customer requests, wherein the central location is determined based on an aggregate of customer-requested locations in the subset of customer requests and comprises global positioning system (GPS) coordinates of a location central to the customer-requested locations of the subset of customer requests;
determining, by the determination component of the computing device and based on the central location, a partner location from the plurality of partner locations, wherein the partner location is located within a predetermined radius of the central location;
deploying, by a deployment component of the computing device, the mobile vehicle to the partner location, wherein the mobile vehicle is configured to fulfill the subset of customer requests;
generating, by a communication component of the computing device, a schedule with appointments for the subset of customer requests;
generating a plurality of modulated data signals to communicate, by the communication component of the computing device, a notification for each customer request in the subset of customer requests, each respective notification comprising the partner location and a corresponding appointment from the schedule, and each respective notification sent to a customer device associated with a respective customer request, wherein a first respective notification corresponding to a first respective customer request in the subset of customer requests identifies a respective corresponding appointment in the schedule that is a divergence from a first respective customer-requested time in the first respective customer request, and wherein the first respective notification indicates the divergence from the first respective customer-requested time is due to a conflict between the first respective customer-requested time in the first respective customer request and a second respective customer-requested time in a second respective customer request in the subset of customer requests; and
fulfilling, by the mobile vehicle, at least a portion of the subset of customer requests at the partner location according to the schedule.

2. (canceled)

3. (canceled)

4. The computer-implemented method of claim 1, further comprising:
verifying, by the determination component, the partner location based on one or more partner credentials, the one or more partner credentials including at least one of service rating, capability, or availability.

5. (canceled)

6. The computer-implemented method of claim 1,
wherein customer requests of the set of customer requests are received through at least one of social media, application, web portal, email, or text message.

7. (canceled)

8. (canceled)

9. The computer-implemented method of claim 1, further comprising:
determining, by the communication component, an optimized schedule of appointments for the subset of customer requests at the partner location, wherein the optimized schedule resolves one or more conflicts within the subset of customer requests.

10. A system, comprising:
one or more processors having instructions to control one or more components, the one or more components comprising:
a partner component configured to:
predefine a plurality of partner locations, wherein partner locations of the plurality of partner locations are predefined to allow deployment of a mobile vehicle at the partner locations;
a request component configured to:
receive a set of customer requests for services of an institution, wherein each request of the set of customer requests is associated with a respective customer and includes service information comprising a respective customer-requested location, a respective customer-requested time, and a respective service type;
parse the set of customer requests to extract, from the service information included in each of the set of customer requests, a set of customer-requested times, a set of customer-requested locations, and a set of service types; and
determine a subset of the set of customer requests based on one or more of the set of customer-requested times, the set of customer-requested locations, and the set of service types;
a determination component configured to:
determine a central location for the subset of customer requests, wherein the central location is determined based on an aggregate of customer-requested locations in the subset of customer requests and comprises global positioning system (GPS) coordinates of a location central to the customer-requested locations of the subset of customer requests; and
determine, based on the central location, a partner location from the plurality of partner locations, wherein the partner location is located within a predetermined radius of the central location;
a deployment component configured to:
deploy the mobile vehicle to the partner location; and
a communication component configured to:
generate a schedule with appointments for the subset of customer requests; and
generate a plurality of modulated data signals to communicate a notification for each customer request in the subset of customer requests, each respective notification comprising the partner location and a corresponding appointment from the schedule, and each respective notification sent to a customer device associated with a respective customer request, wherein a first respective notification corresponding to a first respective customer request in the subset of customer requests identifies a respective corresponding appointment in the schedule that is a divergence from a first respective customer-requested time in the first respective customer request, wherein the first respective notification indicates the divergence from the first respective customer-requested time is due to a conflict between the first respective customer-requested time in the first respective customer request and a second respective customer-requested time in a second respective customer request in the subset of customer requests, and wherein the mobile vehicle is configured to fulfill at least a portion of the subset of customer requests at the partner location according to the schedule.

11. (canceled)

12. (canceled)

13. The system of claim 10, wherein the determination component is further configured to:
verify the partner location based on one or more partner credentials, the one or more partner credentials including at least one of service rating, capability, or availability.

14. (canceled)

15. The system of claim 10, wherein the request component receives the set of customer requests through at least one of social media, application, web portal, email, or text message.

16. (canceled)

17. (canceled)

18. The system of claim 10, wherein the communication component is further configured to:
determine an optimized schedule of appointments for the subset of customer requests at the partner location, wherein the optimized schedule resolves one or more conflicts within the subset of customer requests.

19. A computer-readable storage medium having instructions that when executed by one or more processors control the one or more processors to:
predefine a plurality of partner locations, wherein partner locations of the plurality of partner locations are predefined to allow deployment of a mobile vehicle at the partner locations;
receive a set of customer requests for services of an institution, wherein each request of the set of customer requests is associated with a respective customer and includes service information comprising a respective customer-requested location, a respective customer-requested time, and a respective service type;
parse the set of customer requests to extract from the service information included in each of the set of customer requests, a set of customer-requested times, a set of customer-requested locations, and a set of service types;
determine a subset of the set of customer requests based on one or more of the set of customer-requested times, the set of customer-requested locations, and the set of service types;
determine a central location for the subset of customer requests, wherein the central location is determined based on an aggregate of customer-requested locations in the subset of customer requests and comprises global positioning system (GPS) coordinates of a location central to the customer-requested locations of the subset of customer requests;
determine, based on the central location, a partner location from the plurality of partner locations, wherein the partner location is located within a predetermined radius of the central location;
generate a schedule with appointments for the subset of customer requests;
deploy the mobile vehicle to the partner location, wherein the mobile vehicle is configured to fulfill the subset of customer requests;
generate a plurality of modulated data signals to communicate a notification for each customer request in the subset of customer requests, each respective notification comprising the partner location and a corresponding appointment from the schedule, and each respective notification sent to a customer device associated with a respective customer request, wherein a first respective notification corresponding to a first respective customer request in the subset of customer requests identifies a respective corresponding appointment in the schedule that is a divergence from a first respective customer-requested time in the first respective customer request, and wherein the first respective notification indicates the divergence from the first respective customer-requested time is due to a conflict between the first respective customer-requested time in the first respective customer request and a second respective customer-requested time in a second respective customer request in the subset of customer requests; and
fulfil, by the mobile vehicle, at least a portion of the subset of customer requests at the partner location according to the schedule.

20. (canceled)

21. The computer-implemented method of claim 1, wherein the partner location is determined further based on current traffic conditions.

22. The computer-implemented method of claim 1, wherein the partner location is determined further based on current weather conditions.

23. The computer-implemented method of claim 1, wherein the partner location is determined further based on a current date or time.

24. The computer-implemented method of claim 1, wherein fulfilling, by the mobile vehicle, at least a portion of the subset of customer requests at the partner location according to the schedule includes providing cash to a customer in response to a withdrawal request in the subset of customer requests.

25. The computer-implemented method of claim 1, further comprising determining, based on the set of customer requests, to add a new partner to allow deployment of the mobile vehicle for fulfilling at least a portion of the set of customer requests.

26. The computer-implemented method of claim 25, wherein determination to add the new partner utilizes one or more of a support vector machine, a neural network, a Bayesian belief network, and fuzzy logic.

27. The system of claim 10, wherein fulfilling, by the mobile vehicle, at least a portion of the subset of customer requests at the partner location according to the schedule includes providing cash to a customer in response to a withdrawal request in the subset of customer requests.

28. The system of claim 10, wherein the partner component is further configured to determine, based on the set of customer requests, to add a new partner to allow deployment of the mobile vehicle for fulfilling at least a portion of the set of customer requests.

29. The system of claim 28, wherein determination to add the new partner utilizes one or more of a support vector machine, a neural network, a Bayesian belief network, and fuzzy logic.

30. The computer-readable storage medium of claim 19, wherein the partner location is determined further based on current traffic conditions, current weather conditions, and a current time.

31. The computer-readable storage medium of claim 30, wherein determination of the partner location utilizes one or more of a support vector machine, a neural network, a Bayesian belief network, and fuzzy logic.
